(19) United States
(12) Patent Application Publication
(10) Pub. No.: US 2014/0052574 A1
(43) Pub. Date: Feb. 20, 2014

(54) System For Recording, Supervising and Reporting Electronic Commerce Participants

(71) Applicant: Tsinghua University, Beijing (CN)

(72) Inventors: Hongbo Sun, Beijing (CN); Yueting Chai, Beijing (CN); Yi Liu, Beijing (CN)

(73) Assignee: Tsinghua University, Beijing (CN)

(21) Appl. No.: 13/969,882

(22) Filed: Aug. 19, 2013

(30) Foreign Application Priority Data
Aug. 20, 2012 (CN) 201210298145.5

(51) Int. Cl. G06Q 30/06

(52) U.S. Cl. CPC G06Q 30/0609
USPC 705/26.35

(57) ABSTRACT

A system for recording, supervising and reporting electronic commerce participants is provided. The electronic commerce participants comprise an electronic commerce consumer and an electronic commerce enterprise, the system comprises a sub-server located in an industrial and commercial administration department at a low level and a main server located in the industrial and commercial administration department at a high level communicated with the sub-server via the Internet, the sub-server comprises a registration module, a reporting module and a maintenance module. The main server comprises an business license information module, an enterprise permission information module and an enterprise qualification information module for receiving and storing the enterprise information of the electronic commerce enterprises, a report processing module for processing a report received from the reporting module and a communication module for connecting the main server with the sub-server, a public security administrative department and so on.

### CROSS-REFERENCE TO RELATED APPLICATION

This application claims priority to and benefits of Chinese Patent Application Serial No. 201210298145.5, filed with the State Intellectual Property Office of P. R. China on Aug. 20, 2012, the entire content of which is incorporated herein by reference.

### FIELD

The present disclosure relates to an electronic commerce network field, and more particularly, to a system for recording, supervising and reporting electronic commerce participants.

### BACKGROUND

Since it has such remarkable features as there is no limitation on space and time, live trading is not necessary, whole trade can be done very fast, trading modes and processes are more diversified and individualized than ever, electronic commerce has been observed a very fast development in recent years. At the same time, fraud and criminal behaviors are also increasing with the development of the electronic commerce and risks of electronic transactions are added by features of network such as virtuality, concealment and self-organizing to some extent. Fraud information is publishing and spreading on Internet from time to time. Quality of online products/services is far from satisfactory. Rights and benefits of consumers cannot be protected properly. Ungoverned and illegal behaviors usually happen in electronic commerce markets. Trust in electronic commerce environment is a very important issue.

To ensure a trusted electronic commerce environment, a technology (recording, supervising and reporting electronic commerce participants) of governing electronic commerce participants in electronic commerce markets is proposed and this technology is mainly aiming at governing rather than managing electronic commerce participants.

Nowadays, some countries in the world keep an open attitude to electronic commerce, and only particular products need to be registered in these countries. For example, in America, the government firmly supports the electronic commerce trading except for online drug selling.

Furthermore, according to traditional market governance technologies, only part of the work (such as online business application) uses network and information-based technologies, while most of the work is still done manually. Therefore, the traditional market governance technologies have low efficiency and are not capable of effective governing relations and relative behaviors about whole electronic commerce markets in an online manner.

### SUMMARY

The present disclosure aims at providing a system for recording, supervising and reporting electronic commerce participants, which realizes a standard and network supported governance of the electronic commerce participants and increases trust of the electronic commerce participants.

For this, a system for recording, supervising and reporting electronic commerce participants is provided. The electronic commerce participants comprise an electronic commerce enterprise and an electronic commerce consumer, and the system comprises a sub-server located in an industrial and commercial administration department at a low level and a main server located in the industrial and commercial administration department at a high level communicating with the sub-server. The sub-server comprises: a registration module, configured to register an enterprise information of the electronic commerce enterprise, in which the enterprise information of the electronic commerce enterprise comprises a business license information, an enterprise permission information and an enterprise qualification information; a reporting module, configured to receive a report from the electronic commerce participants, in which the report can be classified into three categories: a report against the electronic commerce enterprise from the electronic commerce consumer, a report against the electronic commerce consumer from the electronic commerce enterprise and a report against a first electronic commerce enterprise from a second electronic commerce enterprise; and a maintenance module, configured to update and maintain the registration information of the electronic commerce enterprise, to transmit the registration information of the electronic commerce enterprise to an industrial and commercial administration department at a higher level, and to store the registration information of the electronic commerce enterprise. The main server comprises: a first information management module, configured to receive the business license information from the sub-server via the Internet and to store the business license information; a second information management module, configured to receive the enterprise permission information from the sub-server via the Internet and to store the enterprise permission information; a third information management module, configured to receive the enterprise qualification information from the sub-server via the Internet and to store the enterprise qualification information; a report processing module, configured to receive the report from the reporting module via the Internet and to process the report according to a reporter type; and a communication module, configured to communicate with a public security administrative department, a host website of the illegal electronic commerce enterprise and a server located in an industrial and commercial administration department at a higher level.

Data items of the report against the electronic commerce enterprise from the electronic commerce consumer comprises: a reporter type, an identification information of the reporter, a network IP address of the reporter, a domain name of an electronic commerce enterprise website, a network IP address of the electronic commerce enterprise, a reporting date, a name, serial number and issuing date of an electronic invoice and a first reporting message, in which the reporting message is related to an authenticity of the enterprise information and a trade information.

Data items of the report against the electronic commerce consumer from the electronic commerce enterprise comprises: the reporter type, the enterprise information of the electronic commerce enterprise, the reporting date, an identification information of the electronic commerce consumer, the network IP address of the electronic commerce consumer, a payment information of the electronic commerce consumer and a second reporting message, in which the second reporting message is related to an authenticity of the identification information of the electronic commerce consumer and a financial information.

Data items of the report against the first electronic commerce enterprise from the second electronic commerce enterprise comprises: the reporter type, the network IP address and enterprise information of the second electronic commerce enterprise, the network IP address and enterprise information of the first electronic commerce enterprise, the reporting date and a third reporting message, in which the third reporting message is related to an authenticity of the report and the trade information.

When the reporter is the electronic commerce consumer and the reported object is the electronic commerce enterprise, it is checked whether the enterprise information of the electronic commerce enterprise is true, if yes, an authenticity of evidence corresponding to the reporting message is further checked, and if no, the report is processed as counterfeiting an enterprise.

When the reporter is the second electronic commerce enterprise and the reported object is the first electronic commerce enterprise, it is checked whether the enterprise information of the second electronic commerce enterprise is true, if yes, an authenticity of the reporting message is checked, and if no, the processing is stopped.

When the reporter is the electronic commerce enterprise and the reported object is the electronic commerce consumer, the identification information of the electronic commerce consumer is transmitted to a related unit of a public security administrative department to check whether the identification information of the electronic commerce consumer is true. If the identification is not true, the electronic commerce consumer is determined as counterfeiting other's identification information, otherwise, the authenticity of evidence corresponding to the reporting message is checked. The electronic commerce consumer may be punished according to the Administrative Law when the evidence is true.

The system for recording, supervising and reporting electronic commerce participants according to the present disclosure can increase normalization and efficiency of governing the electronic commerce participants, increase the trust of the electronic commerce participants and provides supports for realizing a standard, trust, healthy and ordered electronic commerce environment.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a block diagram of a system for recording, supervising and reporting electronic commerce participants according to the present disclosure; and

FIG. 2 is a flow chart of a working process of the system for recording, supervising and reporting electronic commerce participants according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the following, the system for recording, supervising and reporting electronic commerce participants according to the present disclosure will be described in detail with reference to drawings and embodiments. The embodiments are only used to illustrate the present disclosure but not used to limit the scope of the present disclosure.

It should be noted that, the present disclosure is based on the fact that the electronic commerce participants have legal certificates. The legal certificates are the certificates granted by national authorities or subsidiary organizations for identifying people, enterprises or other organizations, which are often documentary certificates. The legal certificates usually comprise: industry and commerce business licenses or individual licenses granted by the State Administration for Industry and Commerce and the Local Administration for Industry and Commerce for identifying enterprises; identification cards granted by the Ministry for Public Security for identifying people; organization codes granted by the national organization code center for identifying all kinds of enterprises, governments, communities and institutions. Furthermore, in the present disclosure, the sub-servers located in the industrial and commercial administration department at a low level are connected with the main servers located in the industrial and commercial administration department at a high level via the Internet, for example, a reliable network connection may be realized by making use of known internet technologies such as VPN technology, which will not be described in detail for the sake of simplicity.

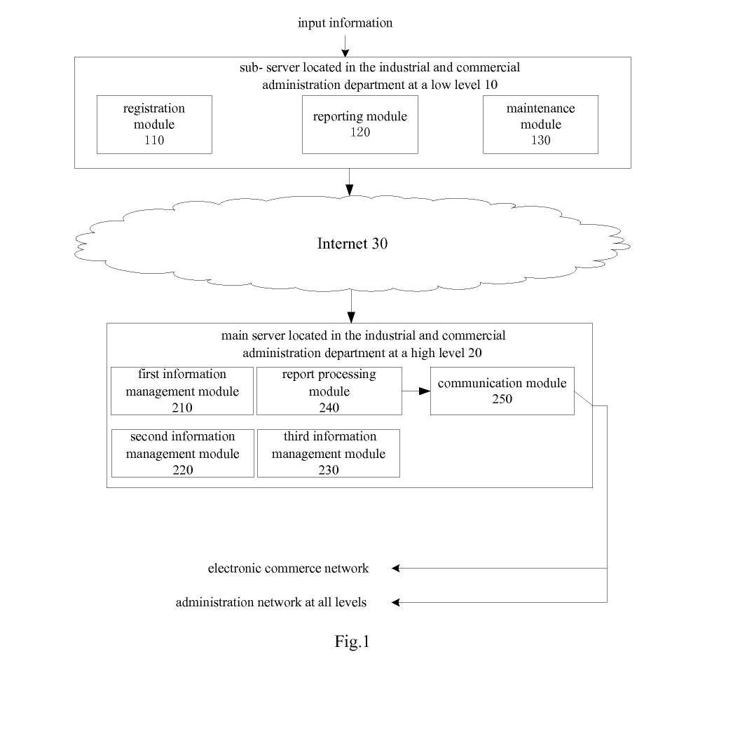

FIG. 1 is a block diagram of a system for recording, supervising and reporting electronic commerce participants according to the present disclosure. In embodiments of the present disclosure, the electronic commerce participants comprise electronic commerce enterprises and electronic commerce consumers, and as shown in FIG. 1, the system for recording, supervising and reporting electronic commerce participants comprises a sub-server 10 located in an industrial and commercial administration department at a low level and a main server 20 located in the industrial and commercial administration department at a high level. The main server 20 communicates with the sub-server 10 via the Internet 30 (such as, the Ethernet). It should be understood that, there may be at least one sub-server 10 in the system.

The sub-server 10 comprises a registration module 110, a reporting module 120 and a maintenance module 130. The registration module 110 is configured to register the enterprise information of the electronic commerce enterprise, the reporting module 120 is configured to receive a report from the electronic commerce participants, and the maintenance module 130 is configured to update and maintain the registration information of the electronic commerce enterprise, to transmit the registration information of the electronic commerce enterprise to the industrial and commercial administration department at a higher level, and to store the registration information of the electronic commerce enterprise. In one embodiment of the present disclosure, the enterprise information of the electronic commerce enterprise comprises an business license information, an enterprise permission information and an enterprise qualification information, and the report comprises a report against the electronic commerce enterprise from the electronic commerce consumer, a report against the electronic commerce consumer from the electronic commerce enterprise and a report against a first electronic commerce enterprise from a second electronic commerce enterprise.

For example, data items of the report against the electronic commerce enterprise from the electronic commerce consumer may comprise: a reporter type, an identification information of the reporter, a network IP address of the reporter, a domain name of an electronic commerce enterprise website, a network IP address of the electronic commerce enterprise, a reporting date, a name, serial number and issuing date of an electronic invoice and a first reporting message, in which the reporting message is related to an authenticity of the enterprise information and a trading information.

Data items of the report against the electronic commerce consumer from the electronic commerce enterprise may comprise: the reporter type, the enterprise information of the electronic commerce enterprise, the reporting date, an identification information of the electronic commerce consumer, the network IP address of the electronic commerce consumer, a payment information of the electronic commerce consumer and a second reporting message, in which the second reporting message is related to an authenticity of the identification information of the electronic commerce consumer and a financial information.

Data items of the report against the first electronic commerce enterprise from the second electronic commerce enterprise may comprise: the reporter type, the network IP address and enterprise information of the second electronic commerce enterprise, the network IP address and enterprise information of the first electronic commerce enterprise, the reporting date and a third reporting message, in which the third reporting message is related to an authenticity of the report and the trading information.

The main server 20 comprises a first information management module 210, a second information management module 220, a third information management module 230, a report processing module 240 and a communication module 250. The first information management module 210, the second information management module 220 and the third information management module 230 are configured to receive different kinds of enterprise information from the sub-server 10 via the Internet and to store the enterprise information. In detail, the first information management module 210 is configured to receive the business license information from the sub-server 10 via the Internet 30 and to store the business license information, the second information management module 220 is configured to receive the enterprise permission information from the sub-server 10 via the Internet 30 and to store the enterprise permission information, the third information management module 230 is configured to receive the enterprise qualification information from the sub-server 10 via the Internet 30 and to store the enterprise qualification information. The report processing module 240 is configured to receive the report from the reporting module 120 via the Internet 30 and to process the report according to a reporter type. The communication module 250 is configured to communicate with a public security administrative department, a host website of the illegal electronic commerce enterprise and a server located in the industrial and commercial administration department at a higher level.

When the reporter is the electronic commerce consumer and the reported object is the electronic commerce enterprise, the report processing module 240 firstly judges whether the enterprise information of the electronic commerce enterprise is true, if yes, further checks an authenticity of evidences corresponding to the reporting message, and if no, processes the report as counterfeiting an enterprise.

When the reporter is the second electronic commerce enterprise and the reported object is the first electronic commerce enterprise, the report processing module 240 firstly checks whether the enterprise information of the second electronic commerce enterprise is true, if yes, further checks an authenticity of the reporting message, and if no, stops processing.

When the reporter is the electronic commerce enterprise and the reported object is the electronic commerce consumer, the report processing module 240 transmits the identification information of the electronic commerce consumer to a related unit of a public security administrative department by the communication module 250 so as to check whether the identification information of the electronic commerce consumer is true. If the identification is not true, the electronic commerce consumer is determined as counterfeiting other's identification information, otherwise, the authenticity of evidences corresponding to the reporting message is checked. The electronic commerce consumer may be punished according to the Administrative Law when the evidences are true.

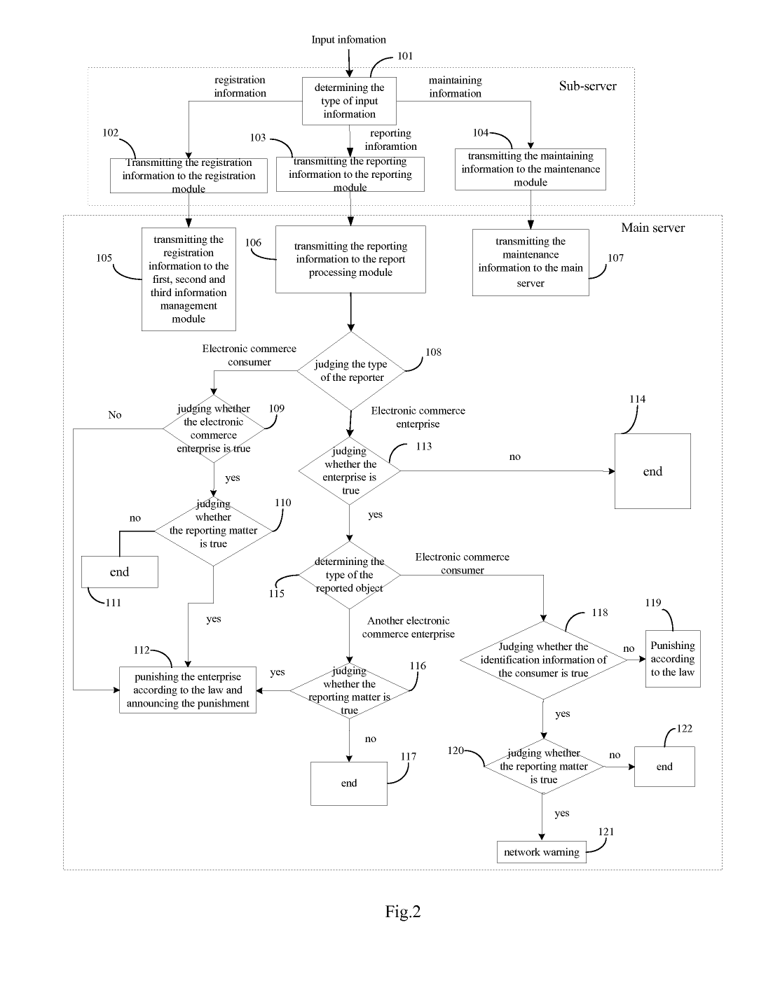

FIG. 2 is a flow chart of the working process of the system for recording, supervising and reporting electronic commerce participants according to an embodiment of the present disclosure. As shown in FIG. 2, the working process comprises the following steps.

At step 101, the type of information input to the industrial and commercial administration department is determined. If the information is a registration information, execute step 102; if the information is a reporting information, execute step 103; if the information is a maintaining information, execute step 104.

At step 102, the registration information is transmitted to the registration module 110.

At step 103, the reporting information is transmitted to the reporting module 120.

At step 104, the maintaining information is transmitted to the maintenance module 130.

At step 105, the registration information is transmitted to the first information management module 210, the second information management module 220 and the third information management module 230 and stored therein respectively.

At step 106, the reporting information is transmitted to the report processing module 240 from the reporting module 120.

At step 107, the maintaining information is transmitted to the main server located in the industrial and commercial administration department at a high level.

At step 108, the report processing module 240 determines the type of the reporter. If the reporter is the electronic commerce consumer, execute step 109; if the reporter is the electronic commerce enterprise, execute step 113.

At step 109, it is judged whether the enterprise information of the electronic commerce enterprise is true, if yes, execute step 110, and if no, execute step 111.

At step 110, it is judged whether the evidence corresponding to the reporting message is true, if yes, execute step 111, and if no, execute step 112.

At step 111, the reporting is not processed.

At step 112, the result is announced on the Internet. In this case, the electronic commerce enterprise may be punished according to the related law.

At step 113, it is judged whether the enterprise information of the electronic commerce enterprise is true, if yes, execute step 115, and if no, execute step 114.

At step 114, the reporting is not processed.

At step 115, the type of the reported object is determined. If the reported object is another electronic commerce enterprise, execute step 116, and if the reported object is the electronic commerce consumer, execute step 118.

At step 116, it is judged whether the evidence corresponding to the reporting message is true, if yes, execute step 112, and if no, execute step 117.

At step 117, the reporting is not processed.

At step 118, the public security department checks whether the identification information of the electronic commerce consumer is true, if no, execute step 119, and if yes, execute step 120.

At step 119, the result is announced on the Internet. In this case, the electronic commerce consumer may be punished according to the related law.

At step 120, it is judged whether the evidence corresponding to the reporting message is true, if yes, execute step 121, and if no, execute step 122.

At step 121, the electronic commerce consumer is warned on the internet.

At step 122, the reporting is not processed.

As the present disclosure uses the automatic inspection technology, the registration efficiency of the electronic commerce participants is greatly improved, which conforms to the operating characteristic of the electronic commerce and the implementation permission requirement of the electronic commerce participants. For example, only 1 second after submitting the information, the electronic commerce participant may perform normal action.

As the present disclosure uses the on-line real-time warning technology, the trust of the electronic commerce participants is greatly improved.

According to the system for recording, supervising and reporting electronic commerce participants of the present disclosure, by storing the registration information of the electronic commerce participants in an information-based and network-based manner, the normalization and efficiency of the registration is increased, the problem which easily happens for manual filling is reduced, and the phenomenon of repeating registration when the same enterprise joins in different electronic commerce networks is avoided. Therefore, the present disclosure can improve the efficiency of electronic commerce trades.

Furthermore, according to the system for recording, supervising and reporting electronic commerce participants of the present disclosure, by using the basic communication device of a third party and storing the relative basic information in the basic communication service device of the third party, it is more convenient for protecting the privacy of the participants and establishing a reliable electronic commerce environment.

In conclusion, according to the present disclosure, risk of an electronic commerce trading may be reduced, fraud may be avoided, the efficiency of inspecting the electronic commerce market may be improved, and finally a steady information basis for establishing a trusted electronic commerce market may be provided. Further, the embodiments of the disclosure applied in the electronic commerce field can efficiently improve the normalization and efficiency of storing the registration information of the electronic commerce participants, improve the trust of the participants in the electronic commerce market, reduce the risk of the electronic commerce trading, avoid cheating, and finally provide a support for establishing a standard, trust, healthy, ordered electronic commerce environment.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A system for recording, supervising and reporting electronic commerce participants, the electronic commerce participants comprising an electronic commerce enterprise and an electronic commerce consumer, wherein the system comprises:
a sub-server located in an industrial and commercial administration department at a low level, the sub-server comprising:
a registration module, configured to register an enterprise information of the electronic commerce enterprise, in which the enterprise information of the electronic commerce enterprise comprises a business license information, an enterprise permission information and an enterprise qualification information;
a reporting module, configured to receive a report from the electronic commerce participants, in which the report comprises a report against the electronic commerce enterprise from the electronic commerce consumer, a report against the electronic commerce consumer from the electronic commerce enterprise and a report against a first electronic commerce enterprise from a second electronic commerce enterprise; and
a maintenance module, configured to update and maintain the registration information of the electronic commerce enterprise, to transmit the registration information of the electronic commerce enterprise to an industrial and commercial administration department at a higher level, and to store the registration information of the electronic commerce enterprise; and
a main server located in the industrial and commercial administration department at a high level, communicating with the sub-server via the Internet and comprising:
a first information management module, configured to receive the business license information from the sub-server via the Internet and to store the business license information;
a second information management module, configured to receive the enterprise permission information from the sub-server via the Internet and to store the enterprise permission information;
a third information management module, configured to receive the enterprise qualification information from the sub-server via the Internet and to store the enterprise qualification information;
a report processing module, configured to receive the report from the reporting module via the Internet and to process the report according to a reporter type; and
a communication module, configured to communicate with a public security administrative department, a host website of the illegal electronic commerce enterprise and a server located in an industrial and commercial administration department at a higher level, wherein,
data items of the report against the electronic commerce enterprise from the electronic commerce consumer comprises: a reporter type, an identification information of the reporter, a network IP address of the reporter, a domain name of an electronic commerce enterprise website, a network IP address of the electronic commerce enterprise, a reporting date, a name, serial number and issuing date of an electronic invoice and a first reporting message, in which the first reporting message is related to an authenticity of the enterprise information and a trading information;
data items of the report against the electronic commerce consumer from the electronic commerce enterprise comprises: the reporter type, the enterprise information of the electronic commerce enterprise, the reporting date, an identification information of the electronic commerce consumer, the network IP address of the electronic commerce consumer, a payment information of the electronic commerce consumer and a second reporting message, in which the second reporting message is related to an authenticity of the identification information of the electronic commerce consumer and a financial information;
data items of the report against the first electronic commerce enterprise from the second electronic commerce enterprise comprises: the reporter type, the network IP address and enterprise information of the second electronic commerce enterprise, the network IP address and enterprise information of the first electronic commerce enterprise, the reporting date and a third reporting message, in which the third reporting message is related to an authenticity of the report and the trading information,
processing the report according to the reporter type comprises:
when the reporter is the electronic commerce consumer and the reported object is the electronic commerce enterprise, checking whether the enterprise information of the electronic commerce enterprise is true, if yes, checking an authenticity of an evidence corresponding to the reporting message, and if no, processing the report as counterfeiting an enterprise;
when the reporter is the second electronic commerce enterprise and the reported object is the first electronic commerce enterprise, checking whether the enterprise information of the second electronic commerce enterprise is true, if yes, checking an authenticity of the reporting message, and if no, stopping processing; and
when the reporter is the electronic commerce enterprise and the reported object is the electronic commerce consumer, transmitting the identification information of the electronic commerce consumer to a related unit of a public security administrative department to check whether the identification information of the electronic commerce consumer is true, if no, determining the electronic commerce consumer as counterfeiting other's identification information, and if yes, checking the authenticity of an evidence corresponding to the reporting message.

2. The system according to the claim 1, wherein the business license information of the electronic commerce enterprise comprises:
a registration number of the electronic commerce enterprise;
an organization code of the electronic commerce enterprise;
a name of the electronic commerce enterprise;
a registration address of the electronic commerce enterprise;
a legal representative of the electronic commerce enterprise;
a company type of the electronic commerce enterprise, comprising a limited liability company and an incorporated company;
a registered capital of the electronic commerce enterprise;
a paid-in capital of the electronic commerce enterprise;
a business scope of the electronic commerce enterprise;
a registration date of the electronic commerce enterprise;
a business allotted time of the electronic commerce enterprise;
a issuing date of a business license of the electronic commerce enterprise;
an issuing government department of the business license of the electronic commerce enterprise; and
a scanning copy of the business license of the electronic commerce enterprise.

3. The system according to claim 1, wherein the enterprise permission information of the electronic commerce enterprise comprises:
a serial number of a license certificate of the electronic commerce enterprise;
an enterprise name of the electronic commerce enterprise;
a registered address of the electronic commerce enterprise;
a legal representative of the electronic commerce enterprise;
an actual business address of the electronic commerce enterprise;
an in-charge government department of the electronic commerce enterprise;
a business premises of the electronic commerce enterprise;
a business scope of the electronic commerce enterprise;
an issuing department of the license certificate;
an expiry date of the license certificate; and
a scanning copy of the permission certificate.

4. The system according to claim 1, wherein the enterprise qualification information of the electronic commerce enterprise comprises:
a serial number of a qualification certificate of the electronic commerce enterprise;
an organization code of the electronic commerce enterprise;
an approval number of the qualification certificate;
an approval date of the qualification certificate;
an issuing date of the qualification certificate;
an issuing organization of the qualification certificate;
a Chinese name of the electronic commerce enterprise;
an English name of the electronic commerce enterprise;
an address of the electronic commerce enterprise;
an economic type of the electronic commerce enterprise, comprising a limited liability company and an incorporated company;
a legal representative of the electronic commerce enterprise;
a competent department of the electronic commerce enterprise;
a registered capital of the electronic commerce enterprise;
a business scope of the electronic commerce enterprise; and
a scanning copy of the qualification certificate.

5. The system according to the claim 1, wherein the identification information of the electronic commerce consumer comprises:
a real name of the electronic commerce consumer;
a gender of the electronic commerce consumer;
a type of an identification document of the electronic commerce consumer, in which the identification document comprises an identification card and an officer card;
a number of the identification document of the electronic commerce consumer;
a contact address of the electronic commerce consumer, comprising a mail address or a living address;
a postal code of the contact address of the electronic commerce consumer;
an administrative division of the electronic commerce consumer;
an e-mail of the electronic commerce consumer;
a contact number of the electronic commerce consumer, comprising a cell phone number and a telephone number; and
a scanning copy of the identification document of the electronic commerce consumer.
